(19) United States
(12) Patent Application Publication
(10) Pub. No.: US 2013/0328669 A1
(43) Pub. Date: Dec. 12, 2013

(54) Tactile Sensation Transmission System

(71) Applicants: AAC ACOUSTIC TECHNOLOGIES (SHENZHEN) CO.,LTD., Shenzhen (CN); AAC MICROTECH (CHANGZHOU) CO.,LTD., Changzhou (CN)

(72) Inventor: Li-hong Zhang, Shenzhen (CN)

(73) Assignees: AAC MICROTECH (CHANGZHOU) CO.,LTD., Changzhou (CN); AAC ACOUSTIC TECHNOLOGIES (SHENZHEN) CO.,LTD., Shenzhen (CN)

(21) Appl. No.: 13/678,530

(22) Filed: Nov. 15, 2012

(30) Foreign Application Priority Data
Jun. 11, 2012 (CN) 201220273651.4

(51) Int. Cl. G08B 6/00

(52) U.S. Cl. CPC G08B 6/00
USPC 340/407.1

(57) ABSTRACT

Disclosed is a tactile sensation transmission system. The tactile sensation transmission system includes a first device for receiving a tactile signal and outputting a communication signal, a communication network for receiving and outputting the communication signal from the first device, and a second device for receiving the communication signal from the network and restoring the communication signal to a driving module for driving a vibration module to generate a tactile sensation on the second device.

### FIELD OF THE INVENTION

The present invention generally relates to the field of data transmission, and more particularly to a system for transmitting tactile sensation between two devices.

### DESCRIPTION OF RELATED ART

As disclosed in U.S. Pat. No. 7,535,454 B2, portable electronic devices, such as mobile phones, portable GPS navigations, laptop computers, generally have a number of buttons that allow a user to interface with the devices by inputting information. The capabilities of these devices are increasing while the size and weight are decreasing to enhance portability. For example, mobile phones, in addition to their traditional role as voice-communication devices, now include functions traditionally associated with other devices, such as electronic games, PDAs, and digital cameras.

To permit effective interaction with the handheld devices, the handheld devices typically provide visual and aural cues or feedback. In addition to conventional visual and aural feedback, some of these devices attempt to enhance the effectiveness of device feedback by providing tactile cues or feedback. Some devices utilize structural tactile methods. One such example is to provide raised surfaces on the input surface, e.g., a keypad, of the device. Such methods, however, are inherently static and thus cannot offer effective tactile feedback.

Active methods of providing tactile feedback include incorporating a vibrator into the handheld electronic devices. Such a method of providing haptic cues, however, generally vibrates the entire device. Such method or apparatuses are disclosed in U.S. Pat. No. 7,535,454 B2, U.S. Pat. No. 7,148,875 B2, U.S. Pat. No. 6,853,965 B2, U.S. Pat. No. 6,429,846 B2, U.S. Pat. No. 6,405,158 B2.

Generally, each type of the tactile feedback apparatuses disclosed in the above-mentioned prior arts could only provide the user who is operating the device with tactile feedback. Only the one who is operating the device gets the feedback from the device. In other words, the tactile feedback is occurred between the operator and the device. Anyone who is not operating the device cannot get tactile feedback from the same device.

Therefore, an improved tactile feedback system is desired to solve the problem mentioned above.

### BRIEF DESCRIPTION OF THE DRAWING

FIG. 1 is a schematic principle diagram of a tactile sensation transmission system in accordance with an exemplary embodiment of the present invention.

Many aspects of the embodiment can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENT

Reference will now be made to describe the exemplary embodiment of the present invention in detail.

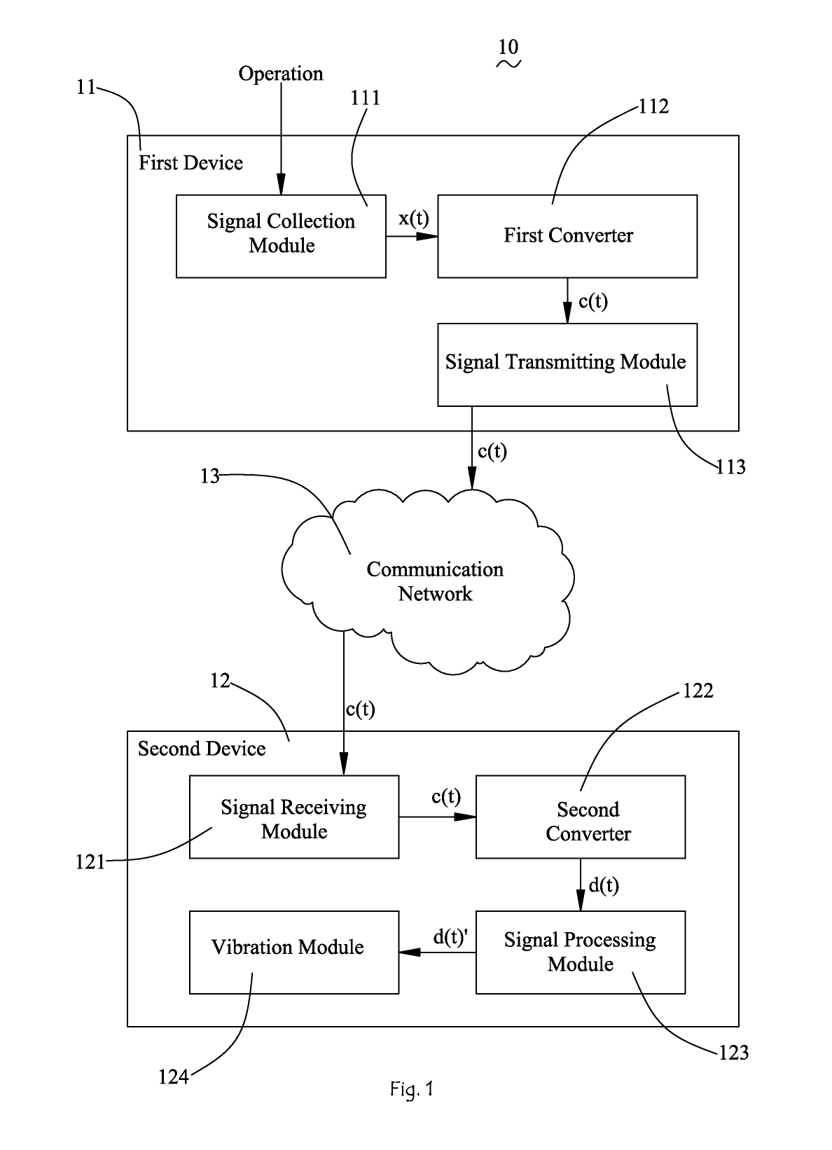

Referring to FIG. 1, which is a schematic principle diagram of a tactile sensation transmission system in accordance with one exemplary embodiment of the present invention, the tactile sensation transmission system 10 includes a first device 11, a second device 12 and a communication network 13 communicating the first device 11 with the second device 12.

The first device 11 may be a mobile phone, a game machine, a display with a touch screen, or any other electronic device. The second device 12 may be a mobile phone, a game machine, a display with a touch screen, or any other electronic device. The communication network 13 is used to receive signals from the first device 11 and transmit the signals from the first device 11 to the second device 12. The communication network 13 may comprise any apparatus having the function of data transmission, such as the Internet, a WI-FI network, a local area network, a ZigBee module, a Bluetooth module, a mobile communication network, and even a data cable.

The first device 11 includes a signal collection module 111, a first converter 112 and a signal transmission module 113. The second device 12 includes a signal receiving module 121, a second converter 122, a signal processing module 123, and a vibration module 124.

The signal collection module 111 of the first device 11 is used for collecting tactile operations from an operator operating the first device 11 and producing a tactile signal x(t). The first converter 112 is used for receiving the tactile signal x(t) directly or indirectly from the signal collection module 111 and then converting the tactile signal x(t) into a communication signal c(t). The signal transmission module 113 is used for receiving the communication signal c(t) from the first converter 112 directly or indirectly and then transmitting the communication signal c(t) to the communication network 13. The communication network 13 is configured to receive the communication signal c(t) from the signal transmission module 113 of the first device 11 and then transmit the communication signal c(t) to the second device 12.

The signal receiving module 121 of the second device 12 is configured to receive the communication signal c(t) from the communication network 13 and then transmit the communication signal c(t) to the second converter 122. The second converter 122 is configured to receive the communication signal c(t) directly or indirectly from the signal receiving module 121 and then convert the communication signal c(t) into a driving signal d(t). The signal processing module 123 is configured to receive the driving signal d(t) directly or indirectly from the second converter 122 and produce an optimized driving signal d(t)′ for driving the vibration module 124 to vibrate for generating a tactile sensation.

When a user operates the first device 11, a tactile signal x(t) will be produced and collected by the signal collection module 111. The signal collection module 111 transmits the tactile signal x(t) to the first converter 121. After receiving the tactile signal x(t) from the signal collection module 111, the first converter 112 converts the tactile signal x(t) to communication signal c(t) for being ready to be transmitted via the communication network 13. The communication signal c(t) is variable according to different communication network 13. For example, for a mobile communication network, such as a GSM network, a WCDMA network, or a LTE network, the communication signal c(t) is substantially compatible with the signals used for voice transmission between two mobile phones. When the communication network 13 receives the communication signal c(t) from the signal transmission module 113 of the first device 11, the signal receiving module 121 of the second device 12 receives the communication signal c(t) from the communication network 13 and then transmits the communication signal c(t) to the second converter 122. After that, the second converter 122 converts the communication signal x(t) to driving signal d(t) which is used for driving the vibration module 124. Before the driving signal d(t) is transmitted to the vibration module 124, the driving signal d(t) could be optimized by the signal processing module 123. For example, the driving signal d(t) could be optimized to be more compatible with the physical characters of the vibration module 124. The driving signal d(t) is optimized to an optimized driving signal d(t)′ for driving the vibration module to vibrate for generating tactile sensation on the second device 12.

In fact, the second converter 122 is configured to restore the tactile signal x(t). But be noted that the driving signal d(t), after being converted by the second converter 122, may or may not different from the tactile signal x(t) because the driving signal d(t) should be configured or converted according to the specific characters of the second device 12. It's feasible provided that the driving signal d(t) is converted based on the tactile signal x(t). It's should be understood that the driving signal d(t) may be same to the tactile signal x(t) for some certain instances.

The signal processing module 123 is configured to optimize the driving signal d(t) before the driving signal d(t) is transmitted to the vibration module 124. It's understood that the signal processing module 123 is optional and the driving signal d(t) may be directly transmitted to the vibration module 124 without the signal processing module 123. Another optional configuration of the signal processing module 123 is to integrate the function of the signal processing module 123 in the second converter 122.

The vibration module 124 is configured to generate vibration for providing tactile sensation feedback. The vibration module 124 may be a linear vibrator, a rotary vibrator, a piezoelectricity vibrator, or other vibrators for providing vibrations.

The signal collection module 111 is configured to pick operation of an user, so, it could be any component capable of sense the operation from the user, such as a pressure sensor, a touch screen, a light sensor, a proximity sensor, or a capacitor transducer.

By virtue the configuration mentioned above, the tactile sensation occurred on one device is transmitted to another device, just like a transmission of voice data. When one is operating a device, another one can receive a tactile sensation feedback on another device according to the operation on the device which is being operated.

While the present disclosure has been described with reference to the specific embodiment, the description of the disclosure is illustrative and is not to be construed as limiting the disclosure. Various of modifications to the present disclosure can be made to the exemplary embodiment by those skilled in the art without departing from the true spirit and scope of the disclosure as defined by the appended claims.

What is claimed is:

1. A tactile sensation transmission system comprising:
a first device comprising a signal collection module for collecting operations on the first device and outputting a tactile signal, a first converter for receiving the tactile signal from the signal collection module and converting the tactile signal to a communication signal, and a signal transmission module for receiving the communication signal from the first converter and outputting the communication signal;
a communication network for receiving the communication signal and outputting the communication signal;
a second device comprising a signal receiving module for receiving the communication signal from the communication network, a second converter for receiving the communication signal from the signal receiving module and converting the communication signal to a driving signal, and a vibration module for receiving the driving signal from the second converter and generating vibration on the second device.

2. The tactile sensation transmission system as described in claim 1, wherein the communication network is selected from Wi-Fi network, local area network, ZigBee module, Bluetooth module, mobile communication network, and data cable.

3. The tactile sensation transmission system as described in claim 1, wherein the signal collection module is selected from pressure sensors, touch screens, light sensors, proximity sensors, and capacitor transducers.

4. The tactile sensation transmission system as described in claim 1, wherein the second device further includes a signal processing module for receiving the driving signal and outputting an optimized driving signal to the vibration module.

5. The tactile sensation transmission system as described in claim 1, wherein the vibration module is selected from linear vibrators, rotary vibrators, piezoelectricity vibrators.

6. A device for a tactile sensation transmission system, comprising:
a signal collection module for collecting operations on the device and outputting a tactile signal;
a first converter for receiving the tactile signal from the signal collection module and converting the tactile signal to a communication signal; and
a signal transmission module for receiving the communication signal from the first converter and outputting the communication signal to an external network.

7. The device for a tactile sensation transmission system as described in claim 6, wherein the signal collection module is selected from pressure sensors, touch screens, light sensors, proximity sensors, and capacitor transducers.

8. A device for a tactile sensation transmission system, comprising:
a signal receiving module for receiving a communication signal converted based on a tactile signal from an external network;
a second converter for receiving the communication signal from the signal receiving module and converting the communication signal to a driving signal; and
a vibration module for receiving the driving signal from the second converter and generating vibration on the device.

9. The device for a tactile sensation transmission system as described in claim 8 further including a signal processing module for receiving the driving signal and outputting an optimized driving signal to the vibration module.

10. The device for a tactile sensation transmission system as described in claim 8, wherein the vibration module is selected from linear vibrators, rotary vibrators, piezoelectricity vibrators.
